(19) United States
(12) Patent Application Publication
(10) Pub. No.: US 2019/0220710 A1
(43) Pub. Date: Jul. 18, 2019

(54) DATA PROCESSING METHOD AND DATA PROCESSING DEVICE

(71) Applicant: ZhongAn Information Technology Service Co., Ltd., Shenzhen (CN)

(72) Inventors: Wenpeng SONG, Shenzhen (CN); Xiong SHEN, Shenzhen (CN)

(21) Appl. No.: 16/362,186

(22) Filed: Mar. 22, 2019

Related U.S. Application Data
(63) Continuation of application No. PCT/CN2018/092390, filed on Jun. 22, 2018.

(30) Foreign Application Priority Data
Jun. 30, 2017 (CN) 201710523102.5

(51) Int. Cl. G06K 9/62; G06N 20/20

(52) U.S. Cl. CPC G06K 9/6282; G06N 20/20; G06K 9/6265

(57) ABSTRACT

A data processing method includes: generating at least one incremental decision tree according to incremental data; predicting the incremental data based on multiple model decision trees in a classification model and the at least one incremental decision tree to obtain prediction results; and updating the classification model according to the prediction results. In the data processing method according to an embodiment of the present invention, by generating the at least one incremental decision tree according to the incremental data, and then predicting the incremental data based on the model decision trees in the classification model and the at least one incremental decision tree, and updating the classification model according to the prediction results, a self-adaptive update of the classification model is achieved, and a manual intervention during a business cycle of the classification model is not needed, so that the cost is saved greatly.

### CROSS-REFERENCE TO RELATED APPLICATIONS

This application is a continuation of International Application No. PCT/CN2018/092390 filed on Jun. 22, 2018, which claims priority to Chinese patent application No. 201710523102.5 filed on Jun. 30, 2017. Both applications are incorporated herein by reference in their entireties.

### TECHNICAL FIELD

Embodiments of the present invention relate to the field of data processing, and particularly to a data processing method and a data processing device.

### BACKGROUND

With development of the Internet technology, a large number of network applications, such as social networking, network reading, stock fund transaction and so on, have emerged. In order to recommend targeted information to users, a network application provider usually processes current data periodically, and then pushes predictive information to the users. In order to improve prediction efficiency and prediction accuracy, a classification model is usually adopted to perform a classification predication operation in most network applications.

A random forest classification model is one of classification models commonly applied, and the random forest classification model consists of multiple decision trees. A sample to be classified may be classified by the multiple decision trees when entering a random forest, and finally a category selected the most by all the decision trees may be selected as a final classification result. In traditional applications, an offline machine learning process is usually adopted to construct the random forest classification model. Knowledge about classification is obtained by learning, analyzing and training the full amount of user behavior data, so that the random forest classification model is constructed completely and deployed online. Over time, the random forest classification model deployed online may tend to degrade gradually, so that a classification accuracy of the random forest classification model may not meet requirements.

In the field of traditional machine learning, a machine learning model is generally based on offline learning. However, as the amount of data increases, a processing capacity of the machine learning model decreases. Especially in the field of financial transactions, information changes rapidly and the machine learning model based on the offline learning may lead to a certain degree of lag in a transaction system.

Therefore, a prediction model that can be updated automatically is urgently needed to process the data.

### SUMMARY

In view of this, an embodiment of the present invention provides a data processing method and a data processing device, in order to solve a problem that existing prediction models all have offline prediction modes and may not achieve a self-adaptive update.

In a first aspect, an embodiment of the present invention provides a data processing method. The data processing method includes: generating at least one incremental decision tree according to incremental data; predicting the incremental data based on multiple model decision trees in a classification model and the at least one incremental decision tree to obtain prediction results; and updating the classification model according to the prediction results.

In an embodiment of the present invention, the generating at least one incremental decision tree according to incremental data includes: extracting multiple sample sets with replacement based on the incremental data; and generating the at least one incremental decision tree based on the multiple sample sets. The number of the at least one incremental decision tree is determined based on the number of the multiple model decision trees.

In an embodiment of the present invention, the updating the classification model according to the prediction results includes: obtaining, according to the prediction results, comprehensive performance of the at least one incremental decision tree and that of the multiple model decision trees; and selecting, based on the comprehensive performance of the at least one incremental decision tree and that of the multiple model decision trees, a predetermined number of decision trees from the multiple model decision trees and the at least one incremental decision tree to act as model decision trees in an updated classification model.

In an embodiment of the present invention, the predetermined number is equal to the number of the multiple model decision trees.

In an embodiment of the present invention, the obtaining, according to the prediction results, comprehensive performance of the at least one incremental decision tree and that of the multiple model decision trees includes: determining the comprehensive performance based on establishing time and prediction accuracy rates to the incremental data of the at least one incremental decision tree and that of the multiple model decision trees.

In an embodiment of the present invention, the predicting the incremental data based on multiple model decision trees in a classification model and the at least one incremental decision tree, includes performing label prediction operations to the incremental data based on the multiple model decision trees in the classification model and the at least one incremental decision tree.

In an embodiment of the present invention, the data processing method further includes: determining, according to results of the label prediction operations, prediction accuracy rates to the incremental data with the multiple model decision trees and the at least one incremental decision tree; and regarding establishing time of the multiple model decision trees and that of the at least one incremental decision tree as weights for determining comprehensive performance, and sorting the prediction accuracy rates to the incremental data. Here, a weight of a decision tree with long establishing time is less than a weight of a decision tree with short establishing time.

In an embodiment of the present invention, the number of the at least one incremental decision trees is determined according to the number of the multiple model decision trees.

In an embodiment of the present invention, the number of the at least one incremental decision trees is equal to 10% to 30% of the number of the multiple model decision trees.

In an embodiment of the present invention, the data processing method further includes: obtaining the incremental data within a predetermined time period, and determining the generated number of the at least one incremental decision tree based on whether the classification model exists; and generating the at least one incremental decision tree according to the incremental data, if the classification model exists.

In an embodiment of the present invention, the data processing method further includes: creating the classification model consisting of the multiple model decision trees according to historical data, if the classification model does not exist, the historical data refers to data that has been classified.

In another embodiment of the present invention, a data processing method includes: obtaining incremental data within a predetermined time period, and determining the generated number of incremental decision trees based on whether a classification model exists; if the classification model exists, generating the at least one incremental decision tree according to the incremental data, and performing label prediction operations to the incremental data based on the at least one incremental decision tree and the model decision trees in the classification model, and the number of the at least one incremental decision tree is determined based on the number of the pre-update model decision trees; determining comprehensive performance of each decision tree of the model decision trees in the classification model and the at least one incremental decision tree; and selecting, based on the comprehensive performance of each decision tree, a predetermined number of decision trees from the model decision trees in the classification model and the at least one incremental decision tree to act as model decision trees in an updated classification model.

In a second aspect, an embodiment of the present invention further provides a data processing device. The data processing device includes a memory, a processor, and a computer program stored in the memory and executed by the processor, when the computer program is executed by the processor, the processor implements the following steps: generating at least one incremental decision tree according to incremental data; predicting the incremental data based on multiple model decision trees in a classification model and the at least one incremental decision tree to obtain prediction results; and updating the classification model according to the prediction results.

In an embodiment of the present invention, when implementing the step of generating at least one incremental decision tree according to incremental data, the processor specifically implements the following steps: extracting multiple sample sets with replacement based on the incremental data; and generating the at least one incremental decision tree based on the multiple sample sets, the number of the at least one incremental decision tree is determined based on the number of the multiple model decision trees.

In an embodiment of the present invention, when implementing the step of updating the classification model according to the prediction results, the processor specifically implements the following steps: obtaining, according to the prediction results, comprehensive performance of the at least one incremental decision tree and that of the multiple model decision trees; and selecting, based on the comprehensive performance of the at least one incremental decision tree and that of the multiple model decision trees, a predetermined number of decision trees from the multiple model decision trees and the at least one incremental decision tree to act as model decision trees in an updated classification model.

In an embodiment of the present invention, the data processing device includes a memory, a processor, and a computer program stored in the memory and executed by the processor, when the computer program is executed by the processor, the processor implements the following steps: obtaining the incremental data for a predetermined time period; generating a first signal characterizing a presence of the classification model and a second signal characterizing an absence of the classification model according to whether the classification model exists; generating the incremental decision tree according to the incremental data based on a responsive first signal; performing label prediction operations to the incremental data according to the model decision trees in the classification model and the incremental decision tree; selecting a predetermined number of the decision trees according to the comprehensive performance of each decision tree of the model decision trees in the classification model and the incremental decision tree; and regarding the selected predetermined number of the decision trees as model decision trees in the updated classification model.

In an embodiment of the present invention, the predetermined number in the updating unit is equal to the number of the multiple model decision trees.

In an embodiment of the present invention, when implementing the step of obtaining, according to the prediction results, comprehensive performance of the at least one incremental decision tree and that of the multiple model decision trees, the processor specifically implements the following step: determining the comprehensive performance based on establishing time and prediction accuracy rates to the incremental data of the at least one incremental decision tree and that of the multiple model decision trees.

In an embodiment of the present invention, when implementing the step of predicting the incremental data based on multiple model decision trees in a classification model and the at least one incremental decision tree to obtain prediction results, the processor specifically implements the following step: performing label prediction operations to the incremental data based on the multiple model decision trees in the classification model and the at least one incremental decision tree.

In an embodiment of the present invention, when implementing the step of predicting the incremental data based on multiple model decision trees in a classification model and the at least one incremental decision tree to obtain prediction results, the processor specifically further implements the following steps: determining, according to results of the label prediction operations, prediction accuracy rates to the incremental data with the multiple model decision trees and the at least one incremental decision tree; regarding establishing time of the multiple model decision trees and that of the at least one incremental decision tree as weights for determining comprehensive performance; and sorting the prediction accuracy rates to the incremental data, a weight of a decision tree with long establishing time is less than a weight of a decision tree with short establishing time.

In an embodiment of the present invention, the number of the at least one incremental decision tree in the incremental decision tree generating module is determined according to the number of the multiple model decision trees.

In an embodiment of the present invention, the number of the at least one incremental decision tree in the incremental decision tree generating module is equal to 10% to 30% of the number of the multiple model decision trees.

In an embodiment of the present invention, when implementing the step of generating at least one incremental decision tree according to incremental data, the processor specifically implements the following steps: obtaining the incremental data within a predetermined time period; and determining the generated number of the at least one incremental decision tree based on whether the classification model exists; the at least one incremental decision tree is generated according to the incremental data, if the classification model exists.

In an embodiment of the present invention, when implementing the step of generating at least one incremental decision tree according to incremental data, the processor specifically further implements the following step: creating the classification model consisting of the multiple model decision trees according to historical data, if the classification model does not exist, the historical data refers to data that has been classified.

In a third aspect, an embodiment of the present invention further provides a computer readable storage medium. The computer readable storage medium stores a data processing program for causing a processor to execute the data processing method according to any one of the embodiments mentioned above.

In the data processing method according to the embodiments of the present invention, the classification model is updated according to the incremental data, so that the classification model may be adjusted timely or near real-time according to a change of sample data, and synchronization of the classification model with the latest sample data is achieved. That is to say, the data processing method according to the embodiment of the present invention may perform a self-adaptive update based on current newly obtained data, so as to adapt to a new trend change of data, and then the accuracy of the prediction is guaranteed. In addition, in the embodiment of the present invention, a manual intervention during a business cycle of the classification model is not needed according to an initial operation setting, so that the cost is saved greatly, and the data processing method according to the embodiment of the present invention possesses characteristics of intelligence and high efficiency.

### BRIEF DESCRIPTION OF DRAWINGS

The embodiments of the present invention will be described with reference to the accompanying drawings. The accompanying drawings are configured to clarify basic principles and thus necessary aspects are merely shown to understand the basic principles. The accompanying drawings are not drawn in proportion. In the accompanying drawings, the same reference sign represents the same or similar feature.

FIG. 1 is a schematic flowchart of a data processing method according to an embodiment of the present invention.

FIG. 2 is a schematic flowchart of an operation of generating at least one incremental decision tree according to incremental data of a data processing method according to an embodiment of the present invention.

FIG. 3 is a schematic flowchart of an operation of updating a classification model according to prediction results of a data processing method according to an embodiment of the present invention.

FIG. 4 is a schematic flowchart of a data processing method according to another embodiment of the present invention.

FIG. 5 is a schematic structural diagram of a data processing device according to an embodiment of the present invention.

FIG. 6 is a schematic structural diagram of an incremental decision tree generating module of a data processing device according to an embodiment of the present invention.

FIG. 7 is a schematic structural diagram of an updating module of a data processing device according to an embodiment of the present invention.

FIG. 8 is a schematic structural diagram of a data processing device according to another embodiment of the present invention.

FIG. 9 is a schematic structural diagram of a decision tree selecting unit of a data processing device according to an embodiment of the present invention.

FIG. 10 is a schematic structural diagram of an electronic equipment according to an embodiment of the present invention.

### DETAILED DESCRIPTION

In the following specific descriptions of preferred embodiments, accompanying drawings which form a part of the present invention are referred. The accompanying drawings illustrate particular embodiments that may achieve the present invention by example. The exemplary embodiments are not intended to exhaust all embodiments according to the present invention. It may be understood that other embodiments may be utilized and structural or logical modifications may also be made on a premise of not deviating from scopes of the present invention. Therefore, the following specific descriptions are not restrictive, and the scopes of the present invention are limited with accompanying claims.

Techniques, methods and equipment known to those skilled in the art may not be discussed in detail, but the techniques, the methods and the equipment may be considered as a part of a specification where appropriate. Connecting lines among units in the accompanying drawings are just for convenience of illustration. One of the connecting lines indicates that the units at both ends of the connecting line are in communication with each other, rather than to limit communication among the units which are not connected.

Inventors have found through research that in the field of traditional machine learning, a machine learning model is generally based on offline learning. However, as the amount of data increases, a processing capacity of the machine learning model decreases. Especially in the field of financial transactions, information changes rapidly and the machine learning model based on the offline learning may lead to a certain degree of lag in a transaction system. In addition, although there are some machine learning models based on online learning, complex structures lead to low work efficiency. Therefore, the machine learning models based on online learning are difficult to be popularized and applied, especially in the financial field where an analysis result needs to be given rapidly.

Based on invention concepts mentioned above, a technical solution for generating an incremental decision tree based on incremental data and then updating a classification model is proposed according to an embodiment of the present invention. It may be understood that the incremental data may refer to financial product information transmitted via the network, such as price, transaction amount, transaction volume and so on.

In machine learning, a random forest classification model is a classifier containing multiple decision trees, and an output classification result of the random forest classification model is determined according to output classification results of all the decision trees. Specifically, a basic idea of the random forest classification model includes randomly extracting N sample sets from original sample sets with replacement, and a sample size of any one of the N sample sets being configured to be the same as that of any one of the original sample sets; establishing N decision trees respectively according to the N sample sets, and any one of the N decision trees being configured to have an option to select a classification result, and then N classification results being obtained; and voting for all the N sample sets according to the N classification results to determine a final classification result. A process of generating the random forest classification model is a process of training each decision tree.

The process of training each decision tree includes the following contents: (1) randomly selecting M samples with replacement and training a decision tree according to the M samples; (2) each sample being configured to have multiple attributes, and randomly selecting m attributes from the multiple attributes when splitting a node of the decision tree, and then selecting a best attribute from the m attributes to act as a split attribute of the node by using a specific strategy; (3) each node of the decision tree being configured to be split according to (2) until it may not be split.

In an actual business application, after obtaining user behavior data, a category prediction operation may be performed by scoring according to a classification model deployed online which is the classification model consisting of a predetermined number of model decision trees. A category with a highest score (the category selected the most by the decision trees) is configured to act as a prediction category, and a pre-set business application may be carried out based on the prediction category, such as judging rise and fall of a price according to the category.

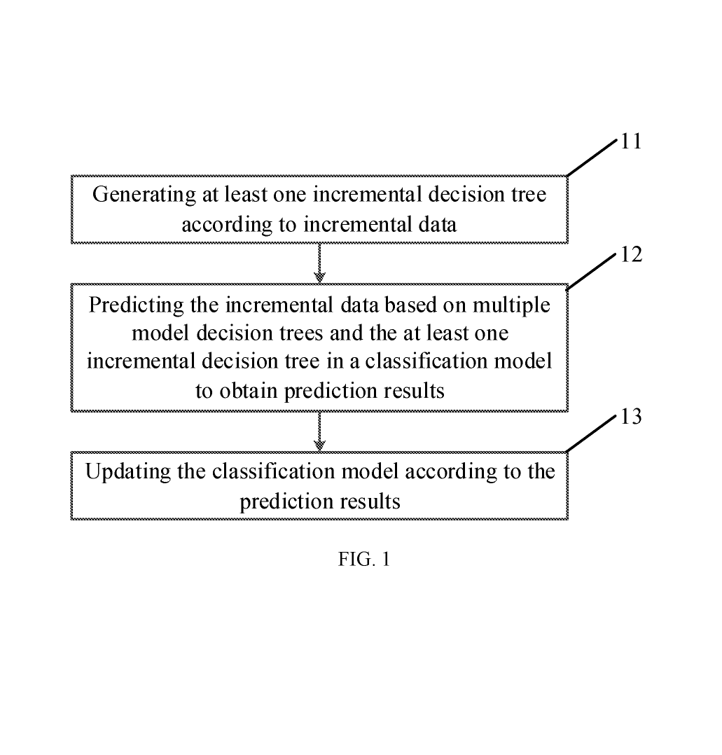

FIG. 1 is a schematic flowchart of a data processing method according to an embodiment of the present invention. The data processing method shown in FIG. 1 may be executed with a server or computing equipment. As shown in FIG. 1, the data processing method according to the embodiment of the present invention includes the following steps.

11: generating at least one incremental decision tree according to incremental data.

In 11, the incremental data refers to new data within a certain period time (such as 10 minutes, 1 hour or 1 day) obtained from a data storage equipment or the server. Each incremental decision tree includes a tree structure, and each internal node of the incremental decision tree represents an attribute test, each branch of the incremental decision tree represents a test output, and each leaf node of the incremental decision tree represents a category.

It may be understood that the attribute and the category represented with each node of the incremental decision tree may be set according to a classification model and an actual application situation.

12: predicting the incremental data based on multiple model decision trees in the classification model and the at least one incremental decision tree to obtain prediction results.

Similarly, each model decision tree includes a tree structure, and each internal node of the model decision tree represents an attribute test, each branch of the model decision tree represents a test output, and each leaf node of the model decision tree represents a category.

Preferably, a prediction operation to the incremental data is performed by using a label prediction method. For example, sampling the incremental data with replacement to extract a certain number of sample sets, and then generating a corresponding number of incremental decision trees based on the sample sets, and finally performing a label prediction operation to the incremental data based on each incremental decision tree.

13: updating the classification model according to the prediction results.

It may be understood that comprehensive performance of each incremental decision tree may be reflected according to the prediction result, especially a prediction accuracy rate to the incremental data.

In an actual application process, firstly the at least one incremental decision tree is generated according to the incremental data, and then the incremental data is predicted based on the model decision trees and the at least one incremental decision tree to obtain the prediction results, and finally an update operation is performed to the model decision trees in the classification model according to the prediction results.

In an embodiment of the present invention, the update operation refers to select one or more incremental decision trees with better comprehensive performance to replace one or more model decision trees with poor comprehensive performance in the pre-update classification model.

In the data processing method according to the embodiment of the present invention, by means of generating the at least one incremental decision tree according to the incremental data, and then predicting the incremental data based on the model decision trees in the classification model and the at least one incremental decision tree, and updating the classification model according to the prediction results, a self-adaptive update of the classification model is achieved, and a manual intervention during a business cycle of the classification model is not needed, so that the cost is saved greatly.

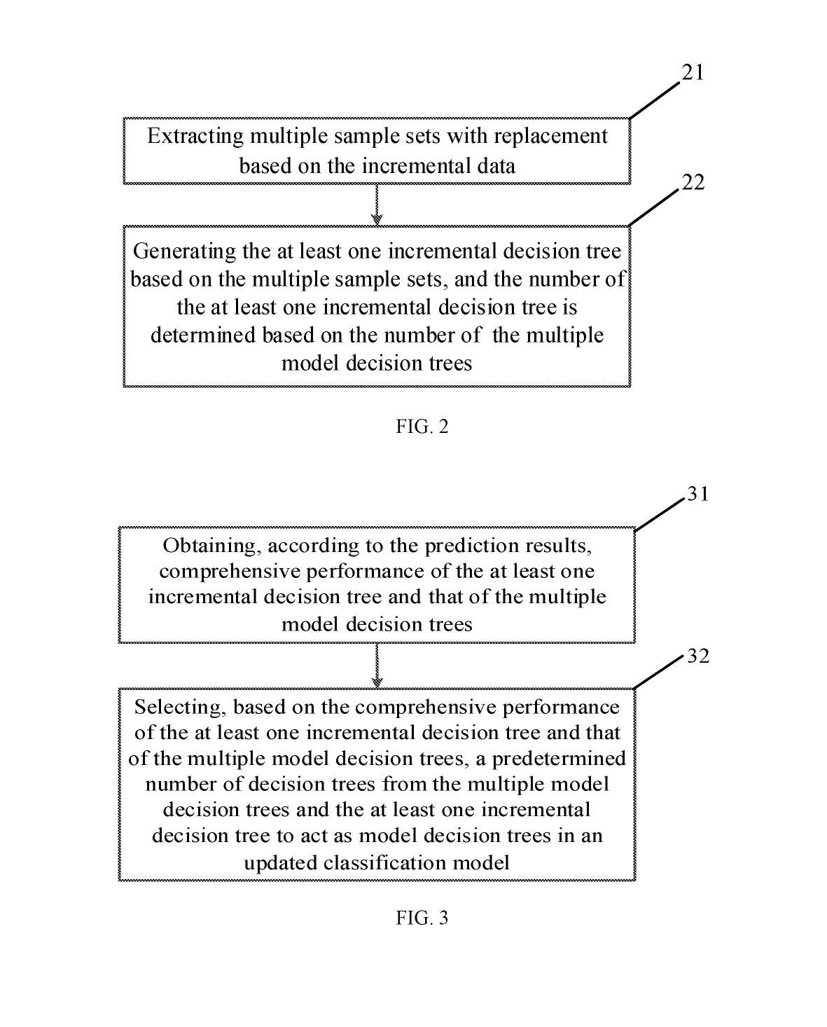

FIG. 2 is a schematic flowchart of an operation of generating at least one incremental decision tree according to incremental data of a data processing method according to an embodiment of the present invention. As shown in FIG. 2, in the data processing method according to the embodiment of the present invention, the generating at least one incremental decision tree according to incremental data (11) includes the following steps.

21: extracting multiple sample sets with replacement based on the incremental data.

22: generating the at least one incremental decision tree based on the multiple sample sets, and the number of the at least one incremental decision tree is determined based on the number of the multiple model decision trees.

In an actual application process, firstly the multiple sample sets is extracted with replacement based on the incremental data, and then the at least one incremental decision tree is generated based on the sample sets, here, the number of the incremental decision trees is determined based on the number of the model decision trees, and then the incremental data is predicted based on the model decision trees in the classification model and the at least one incremental decision tree to obtain prediction results, and finally an update operation is performed to the classification model according to the prediction results.

In the data processing method according to the embodiment of the present invention, by means of generating the at least one incremental decision tree by extracting the multiple sample sets with replacement, each node of each incremental decision tree is selected from a characteristic of the sample sets, so that a precondition is provided for improving a prediction accuracy rate of the classification model.

FIG. 3 is a schematic flowchart of an operation of updating a classification model according to prediction results of a data processing method according to an embodiment of the present invention. As shown in FIG. 3, in the data processing method according to the embodiment of the present invention, the updating the classification model according to the prediction results (13) includes the following steps.

31: obtaining, according to the prediction results, comprehensive performance of the at least one incremental decision tree and that of the multiple model decision trees.

It may be understood that an evaluation parameter in the comprehensive performance may be set independently according to an actual situation, including but is not limited to the evaluation parameter such as establishing time, a prediction accuracy rate and so on.

32: selecting, based on the comprehensive performance of the at least one incremental decision tree and that of the multiple model decision trees, a predetermined number of decision trees from the multiple model decision trees and the at least one incremental decision tree to act as model decision trees in an updated classification model.

That is, in the data processing method according to the embodiment of the present invention, the model decision trees in the pre-update classification model are updated selectively according to the comprehensive performance of each decision tree. That is, some of the model decision trees in the pre-update classification model are replaced with incremental decision trees with better comprehensive performance, so that an accurate prediction of the updated classification model is achieved.

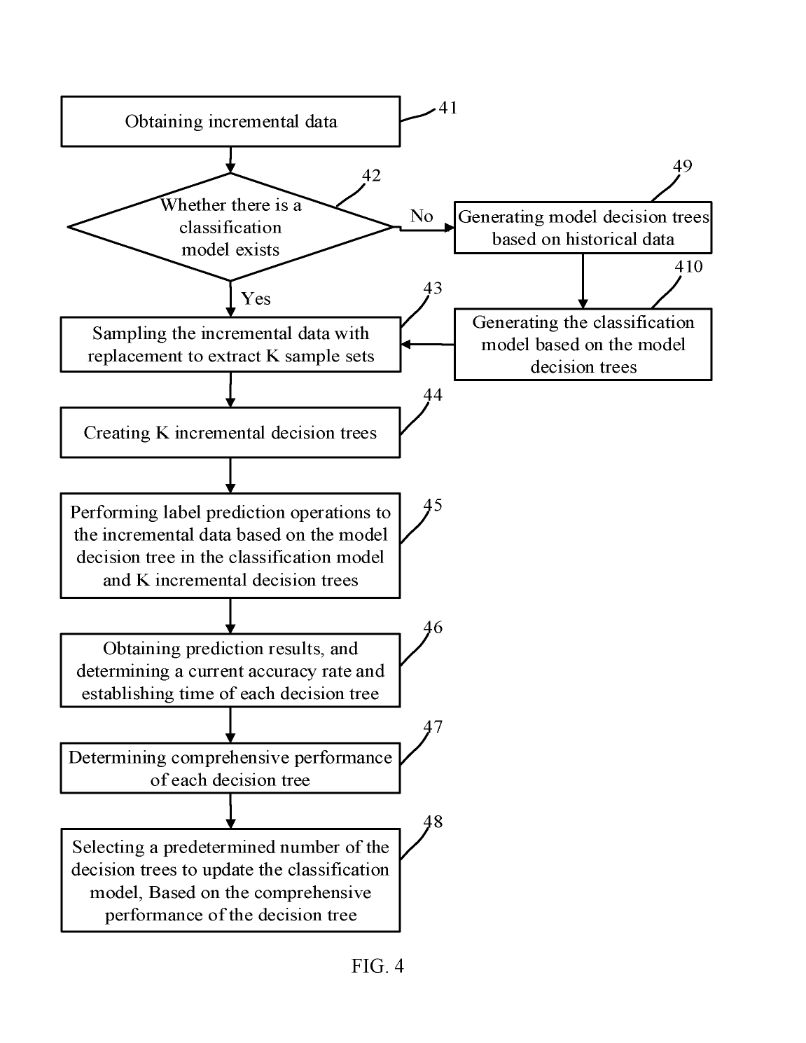

FIG. 4 is a schematic flowchart of a data processing method according to another embodiment of the present invention. As shown in FIG. 4, the data processing method according to the embodiment of the present invention includes the following steps.

41: obtaining incremental data.

In an embodiment of the present invention, the obtaining incremental data refers to obtaining the incremental data within a predetermined time period from a financial transaction server or a specific storage device. The predetermined time period refers to a time period before the current time. A length of the predetermined time period may be set according to a specific requirement, as long as user behavior data within the predetermined time period is already in an available state and already contains actual category label information. For example, the length of the predetermined time period may be in days, in hours or in minutes.

In an embodiment of the present invention, a financial product (such as stock) transaction is taken as an example for description. For example, in a stock transaction system, transaction data within 5 minutes from the current time is obtained, and a label of the transaction data may be one of rising, falling and flat. That is, the predetermined time period is a time period within 5 minutes before the current time. It may be understood that the label of the data may have many other forms in other embodiments.

42: judging whether there is a classification model deployed online.

In 42, it will be determined whether there is a classification model that may be used, if the classification model exists, then 43 is executed, otherwise 49 is executed.

The following different scenarios are described respectively based on whether the classification model exists.

Scenario 1: the classification model exists.

43: sampling the incremental data with replacement to extract K sample sets.

In 43, sample the obtained incremental data with replacement to generate K training sample sets. Each sample has a form similar to the following: (x₁, x₂ . . . xₙ:c), here, xᵢ(=1,2 . . . n) represents attributes of the sample, and c represents an actual category of the sample. For example, in a specific example of the embodiment of the present invention, in the field of financial transaction business, the classification model is adopted to classify and predict a trend of a stock price, and the attributes of each sample may selectively include specific attributes such as stock name, price, transaction volume and so on.

It may be understood that a specific value of K may be set independently according to an actual situation to fully improve adaptability and wide application of the data processing method according to the embodiment of the present invention. The specific value of K does not be uniformly limited by the embodiment of the present invention.

44: creating K incremental decision trees based on the K sample sets.

In 44, each sample set grows into a corresponding incremental decision tree, that is, each node of each incremental decision tree is a feature selected from the sample set.

45: performing label prediction operations to the incremental data based on the model decision trees in the classification model and the K incremental decision trees.

In 45, perform the label prediction operations (that is, classification prediction operations) to the incremental data based on the model decision trees (assumed T) in the classification model and the K incremental decision trees to classify the unclassified incremental data, so that there are a total of T+K decision trees to perform the label prediction operations to the incremental data. Because the total number of the decision trees participating in a prediction operation increases and the K incremental decision trees may represent new trend changes, therefore, the prediction accuracy rate of the classification model is beneficial to be improved by using the T+K decision trees.

In an embodiment of the present invention, in order to prevent accuracy and applicability of the classification model being damaged with the K incremental decision trees newly added, the value range of K is set from 0.1T to 0.3T.

It may be noted that the letters T and K are merely configured to characterize a difference between the number of the model decision trees in the classification model and the number of the incremental decision trees generated according to the incremental data in the classification model, and are not intended to limit T, K to a specific value, such as an integer greater than or equal to 1.

46: obtaining prediction results, and determining a current accuracy rate and establishing time of each decision tree.

In 46, obtain the prediction results firstly based on the label prediction operations executed in 45, and then compare each prediction result with a true result, so that the current accuracy rate of each decision tree is obtained, that is, the prediction accuracy rate to the incremental data. Meanwhile, the establishing time of each decision tree may be further obtained, that is, a time that each decision tree already exists.

47: determining comprehensive performance of each decision tree.

By executing 46, the prediction accuracy rate of each decision tree and the establishing time of each decision tree have been determined. In this embodiment, the comprehensive performance of each decision tree will be determined with the two parameters.

In an embodiment, the comprehensive performance is equal to a sum of a product of a and the establishing time and a product of b and the prediction accuracy rate, here a and b are weights of the establishing time and the prediction accuracy rate respectively. A value of a and a value of b may be adjusted according to an actual situation. It may be seen from this, the establishing time of each the decision tree also affects the comprehensive performance of the decision tree, and that is, a weight of a decision tree nearer from the current time is greater than that further from the current time. In other words, by configuring the values of a and b, comprehensive performance of a decision tree with shorter establishing time is better than that with longer establishing time when the prediction accuracy rates of the two decision trees are the same.

It may be understood that an expression among the comprehensive performance, the establishing time and the prediction accuracy rate exemplified here is merely intended to explain that the comprehensive performance is related to the establishing time and the prediction accuracy rate, and is not configured to limit that the comprehensive performance may only be equal to the sum of the establishing time and the prediction accuracy rate. A determining process of the comprehensive performance of some decision trees is described below in combination with Table 1.

TABLE 1
comprehensive performance of decision trees

| ID of | Prediction | Establishing | Sort of |
|---|---|---|---|
| Decision | Accuracy | Time | Comprehensive |
| Tree | Rate | (hour) | Performance |
| 3 | 90% | 5 | 1 |
| 1 | 85% | 5 | 2 |
| 2 | 83% | 8 | 3 |
| 4 | 80% | 8 | 4 |
| 5 | 80% | 9 | 5 |

In this embodiment, the establishing time is introduced to act as a weight that affects the comprehensive performance of each decision tree. For a case where the prediction accuracy rates of two decision trees are the same (for example, a prediction accuracy rate of a decision tree 4 and that of a decision tree 5 are both 80%), comprehensive performance of the two decision trees are further determined according to the establishing time of the two decision trees. That is, because the establishing time of the decision tree 4 is shorter than that of the decision tree 5, so that a conclusion that the comprehensive performance of the decision tree 4 is better than that of the decision tree 5 is drawn.

48: selecting a predetermined number of the decision trees to update the classification model based on the comprehensive performance of the decision trees.

In 48, select the predetermined number of the decision trees to act as the model decision trees of the updated classification model according to the comprehensive performance of the decision trees. The sort of the comprehensive performance of the decision trees is obtained according to the label prediction results to the incremental data with the decision trees. For example, the decision trees are sorted based on the comprehensive performance of the decision trees to obtain a decision tree sequence shown in Table 1 that is sorted according to the comprehensive performance, and a decision tree with excellent comprehensive performance is selected according to a sort result. It may be seen from the foregoing that when the weight of the establishing time is considered, the comprehensive performance of the decision tree 4 is better than that of the decision tree 5. Therefore, if four decision trees need to be selected and one decision tree needs to be discarded, thus the decision tree 5 is discarded and the decision trees 1 to 4 are selected as the model decision trees of the classification model. The updated classification model is configured to predict subsequent incremental data.

It may be seen from the above that in the data processing method according to the embodiment of the present invention, an update operation to the classification model may be achieved under a premise of guaranteeing the prediction accuracy rate of the classification model.

Preferably, the number K of the incremental decision trees is determined according to the number T of the model decision trees in the classification model.

In an embodiment of the present invention, the number K of the incremental decision trees ranges from 10% to 30% of the number T of the model decision trees in the classification model. Further, the specific value of K may be randomly determined between 10% and 30% of T according to a user instruction or an application scenario, so that the number T of the model decision trees in the classification model may also be changed correspondingly. It may be understood that the classification model may be updated without affecting stability of the classification model according to a limitation to the number of the incremental decision trees in the embodiment of the present invention.

In another embodiment, the number of selected predetermined number of the decision trees is equal to the number of original model decision trees in the classification model, that is, the number of the model decision trees in the classification model is always kept at T, and the number of discarded decision trees is equal to the number of the incremental decision trees.

In order to better express concepts of the embodiments of the present invention, the following description is made by taking T=200 and K=40 as an example. Please referring to FIG. 4 again, in the embodiment of the present invention, by executing 45, the label prediction operations to the incremental data are performed by using T+K (that is, 240) decision trees, and then the comprehensive performance of the decision trees is sorted according to the prediction results. According to a sort result, 190, 200 or 210 decision trees are selected from the 240 decision trees to act as the model decision trees of the classification model, thereby the update operation of the classification model is completed. Accordingly, K may be any number of 0.1T to 0.3T or a user-specified number when the update operation is performed with the classification model next time.

Scenario 2: the classification model does not exist.

Referring to FIG. 4 continuously, if it is judged in 42 that there is no available classification model, then 49 is executed, that is, the model decision trees are generated based on historical data. For example, the historical data is sampled to form T sample sets, and then T model decision trees are generated based on the T sample sets. It may be understood that the historical data refers to the data that has been classified.

Then 410 is executed, and the classification model is constituted according to the T model decision trees generated by 49. By executing 410, the label prediction operations may be performed to the incremental data with the classification model newly created (that is, executing continuously the subsequent operations such as 43).

It may be noted that in the embodiment of the present invention, the classification model is updated with the incremental data instead of adapting a traditional offline calculation method to reconstruct the classification model based on full-quantity data, so that the classification model may be adjusted timely or near real-time according to a change of sample data, and synchronization of the classification model with the latest sample data is achieved. At the same time, in the embodiment of the present invention, a manual intervention during a business cycle of the classification model is not needed according to an initial operation setting, so that the cost is saved greatly, and the data processing method according to the embodiment of the present invention possesses characteristics of intelligence and high efficiency.

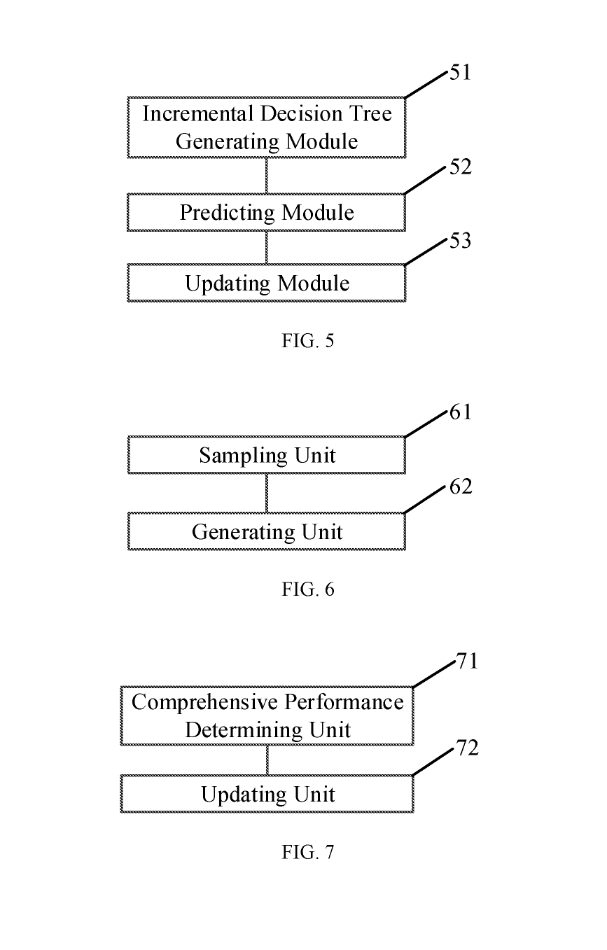

FIG. 5 is a schematic structural diagram of a data processing device according to an embodiment of the present invention. As shown in FIG. 5, the data processing device according to the embodiment of the present invention includes: an incremental decision tree generating module 51, configured to generate at least one incremental decision tree according to incremental data; a predicting module 52, configured to predict the incremental data based on multiple model decision trees in a classification model and the at least one incremental decision tree to obtain prediction results; and an updating module 53, configured to update the classification model according to the prediction results.

In an embodiment of the present invention, the predicting module 52 is configured to perform label prediction operations to the incremental data according to the multiple model decision trees in the classification model and the at least one incremental decision tree.

In another embodiment of the present invention, the predicting module 52 is further configured to determine, according to results of the label prediction operations, prediction accuracy rates to the incremental data by the multiple model decision trees and the at least one incremental decision tree; and regard establishing time of the multiple model decision trees and that of the at least one incremental decision tree as weights for determining comprehensive performance, and sort the prediction accuracy rates to the incremental data. Here, a weight of a decision tree with long establishing time is less than a weight of a decision tree with short establishing time.

In an embodiment of the present invention, the number of the at least one incremental decision tree in the incremental decision tree generating module 51 is determined according to the number of the multiple model decision trees.

In another embodiment of the present invention, the number of the at least one incremental decision tree in the incremental decision tree generating module 51 is equal to 10% to 30% of the number of the multiple model decision trees.

In another embodiment of the present invention, the incremental decision tree generating module 51 is further configured to obtain the incremental data within a predetermined time period, and determine the generated number of the at least one incremental decision tree according as whether the classification model exists. Here if the classification model exists, the at least one incremental decision tree is generated according to the incremental data.

In another embodiment of the present invention, the incremental decision tree generating module 51 is further configured to create the classification model including the multiple model decision trees according to historical data, if the classification model does not exist. Here the historical data refers to the data that has been classified.

FIG. 6 is a schematic structural diagram of an incremental decision tree generating module of a data processing device according to an embodiment of the present invention. As shown in FIG. 6, the incremental decision tree generating module 51 of the data processing device according to the embodiment of the present invention includes: a sampling unit 61, configured to extract multiple sample sets with replacement based on the incremental data; and a generating unit 62, configured to generate at least one incremental decision tree based on the multiple sample sets, and the number of the at least one incremental decision tree is determined based on the number of multiple model decision trees.

FIG. 7 is a schematic structural diagram of an updating module of a data processing device according to an embodiment of the present invention. As shown in FIG. 7, the updating module 53 of the data processing device according to the embodiment of the present invention includes: a comprehensive performance determining unit 71, configured to obtain, according to the prediction result, a comprehensive performance of the at least one incremental decision tree and that of multiple model decision trees; and an updating unit 72, configured to select, based on the comprehensive performance of the at least one incremental decision tree and that of the multiple model decision trees, a predetermined number of decision trees from the multiple model decision trees and the at least one incremental decision tree to act as model decision trees in the updated classification model.

In an embodiment of the present invention, the predetermined number in the updating unit 72 is equal to the number of the multiple model decision trees.

In an embodiment of the present invention, the comprehensive performance determining unit 71 is further configured to determine the comprehensive performance according to establishing time and prediction accuracy rates to the incremental data of the at least one incremental decision tree and that of the multiple model decision trees.

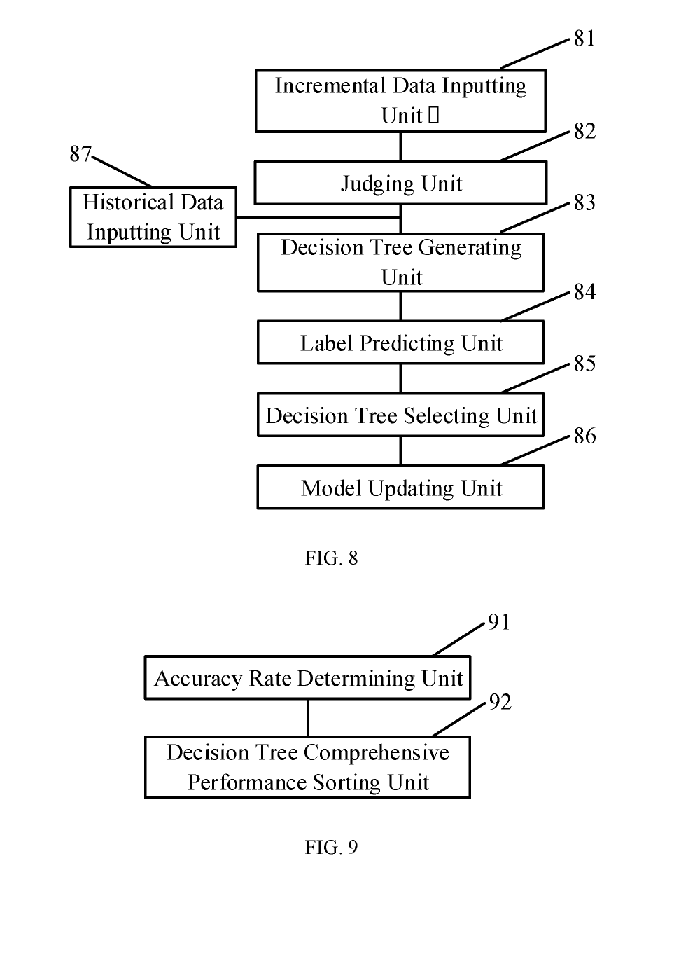

FIG. 8 is a schematic structural diagram of a data processing device according to another embodiment of the present invention. As shown in FIG. 8, the data processing device according to the embodiment of the present invention includes: an incremental data inputting unit 81, configured to obtain incremental data within a predetermined time period; a judging unit 82, configured to generate a first signal characterizing a presence of a classification model and a second signal characterizing an absence of the classification model according as whether the classification model exists; a decision tree generating unit 83, configured to generate an incremental decision tree from the incremental data based on the first signal; a label predicting unit 84, configured to perform label prediction operations to the incremental data according to a model decision tree and the incremental decision tree in the classification model; a decision tree selecting unit 85, configured to select a predetermined number of decision trees according to comprehensive performance of each decision tree of the model decision tree and the incremental decision tree in the classification model; and a model updating unit 86, configured to regard the selected predetermined number of decision trees as the model decision trees in an updated classification model.

From this, in the data processing device according to the embodiment of the present invention, the incremental data may be predicted by using the classification model after obtaining the incremental data, and the classification model may be updated based on the incremental data. That is, in the data processing device according to the embodiment of the present invention, a self-adaptive update of the classification model is achieved.

In an embodiment, the number of the predetermined number of the decision trees selected by the decision tree selecting unit 85 is equal to the number of original model decision trees in the classification model.

In an embodiment of the present invention, the data processing device further includes a historical data inputting unit 87 configured to obtain historical data that has been classified. For example, when the judging unit 82 does not find an available classification model, the decision tree generating unit 83 generates the model decision trees from the historical data according to the second signal generated by the judging unit 82, and then the available classification model is generated.

FIG. 9 is a schematic structural diagram of a decision tree selecting unit of a data processing device according to an embodiment of the present invention. As shown in FIG. 9, in the data processing device according to the embodiment of the present invention, the decision tree selecting unit 85 includes an accuracy rate determining unit 91 and a decision tree comprehensive performance sorting unit 92. The accuracy rate determining unit 91 is configured to determine prediction accuracy rates of the decision trees to incremental data according to label prediction results. The decision tree comprehensive performance sorting unit 92 is configured to sort the decision trees based on establishing time of the decision trees and the prediction accuracy rates to the incremental data of the decision trees. Here a weight of a decision tree with long establishing time is less than a weight of a decision tree with short establishing time. It may be understood that in the data processing device according to the embodiment of the present invention, the classification model may be adjusted according to a trend of data change, which contributes to improve or maintain the prediction accuracy rate of the classification model.

It may be understood that, in the data processing device shown in the FIGS. 5 to 9, operations and functions of the incremental decision tree generating module 51, the predicting module 52, the updating module 53, and the sampling unit 61 and the generating unit 62 contained in the incremental decision tree generating module 51, and the comprehensive performance determining unit 71 and the updating unit 72 contained in the updating module 53 may refer to the data processing method shown in the forgoing FIGS. 1 to 4. It will not be described redundantly herein so as to avoid redundancy.

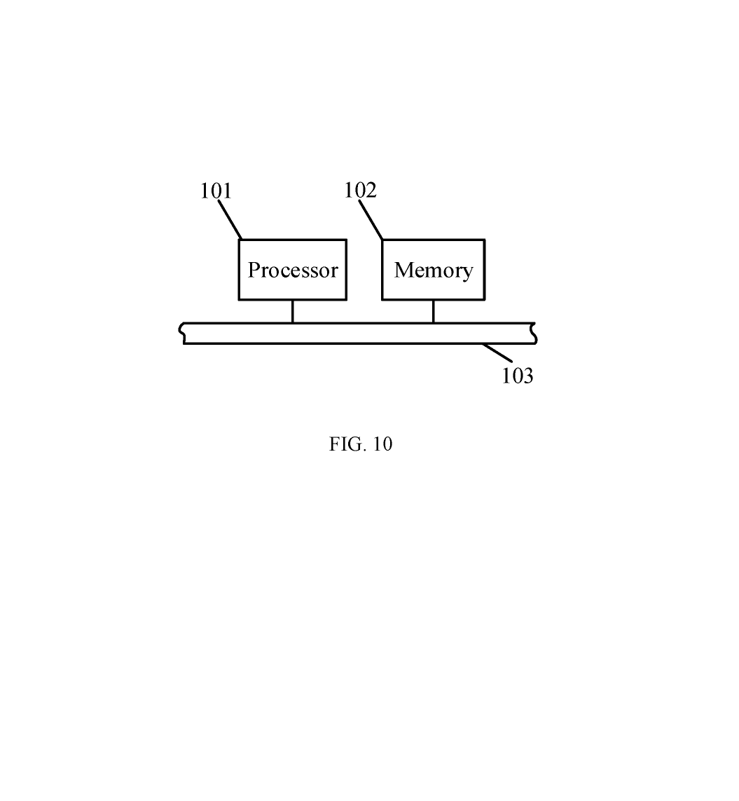

FIG. 10 is a schematic structural diagram of an electronic equipment according to an embodiment of the present invention. The electronic equipment shown in FIG. 10 is configured to execute the data processing method described in the embodiments of the FIGS. 1 to 4. As shown in FIG. 10, the electronic equipment includes a processor 101, a memory 102 and a bus 103.

The processor 101 is configured to call a code stored in the memory 102 through the bus 103 to generate at least one incremental decision tree according to incremental data, and predict the incremental data based on multiple model decision trees in a classification model and the at least one incremental decision tree to obtain a prediction result, and update the classification model according to the prediction result.

It may be understood that the electronic equipment includes but is not limited to an electronic equipment such as a mobile phone, a tablet computer and so on.

In an embodiment of the present invention, a computer readable storage medium is further provided. A data processing program is stored in the computer readable storage medium. When the data processing program is executed by a processor, steps of the data processing method described in any one of the forgoing embodiments mentioned above are realized.

It may be understood that the computer readable storage medium refers to a memory such as a CD-ROM, a floppy disk, a hard disk, a Digital Versatile Disk (DVD), a blue-ray disk and so on. Alternatively, some or all operations of the exemplary methods in FIGS. 1 to 4 may be achieved according to any combination of an Application Specific Integrated Circuit (ASIC), a Programmable Logic Device (PLD), an Erasable Programmable Logic Device (EPLD), a discrete logic, a hardware, a firmware and so on. In addition, although the flowcharts shown in FIGS. 1 to 4 describe the data processing method, an operation in the processing method may be modified, deleted, or merged.

As described above, any exemplary process of FIGS. 1 to 4 may be achieved according to a coded instruction (such as a computer readable instruction). The coded instruction is stored on a tangible computer readable storage medium such as a hard disk, a flash memory, a Read Only Memory (ROM), a Compact Disc (CD), a Digital Versatile Disc (DVD), a cache, a Random Access Memory (RAM), and/or any other storage mediums. In the tangible computer readable storage medium, information may be stored for any time (such as long time, permanence, transience, temporary buffering, and/or caching of information). As used herein, the term the tangible computer readable storage medium is expressly defined to include any type of computer readable stored signals. Additionally or alternatively, the exemplary process of FIG. 1 may be achieved according to the coded instruction (such as the computer readable instruction), and the coded instruction is stored on a non-transitory computer readable storage medium such as a hard disk, a flash memory, a ROM, a CD, a DVD, a cache, a RAM, and/or any other storage mediums. In the non-transitory computer readable storage medium, information may be stored for any time (such as long time, permanence, transience, temporary buffering, and/or caching of information).

Therefore, although the present invention is described by referring to the specific examples, these specific examples are merely intended to be exemplary, and not limit the present invention. It is obvious to those skilled in the art that the disclosed embodiments may be changed, added or deleted on the basis of not deviating from spirit and protection scope of the present invention.

What is claimed is:

1. A data processing method, comprising:
generating at least one incremental decision tree according to incremental data;
predicting the incremental data based on multiple model decision trees in a classification model and the at least one incremental decision tree to obtain prediction results; and
updating the classification model according to the prediction results.

2. The data processing method according to claim 1, wherein the generating at least one incremental decision tree according to incremental data comprises:
extracting multiple sample sets with replacement based on the incremental data; and
generating the at least one incremental decision tree based on the multiple sample sets, wherein the number of the at least one incremental decision tree is determined based on the number of the multiple model decision trees.

3. The data processing method according to claim 1, wherein the updating the classification model according to the prediction results comprises:
obtaining, according to the prediction results, comprehensive performance of the at least one incremental decision tree and that of the multiple model decision trees; and
selecting, based on the comprehensive performance of the at least one incremental decision tree and that of the multiple model decision trees, a predetermined number of decision trees from the multiple model decision trees and the at least one incremental decision tree to act as model decision trees in an updated classification model.

4. The data processing method according to claim 3, wherein the predetermined number is equal to the number of the multiple model decision trees.

5. The data processing method according to claim 3, wherein the obtaining, according to the prediction results, comprehensive performance of the at least one incremental decision tree and that of the multiple model decision trees comprises:
determining the comprehensive performance based on establishing time and prediction accuracy rates to the incremental data of the at least one incremental decision tree and that of the multiple model decision trees.

6. The data processing method according to claim 1, wherein the predicting the incremental data based on multiple model decision trees in a classification model and the at least one incremental decision tree comprises:
performing label prediction operations to the incremental data based on the multiple model decision trees in the classification model and the at least one incremental decision tree.

7. The data processing method according to claim 6, further comprising:
determining, according to results of the label prediction operations, prediction accuracy rates to the incremental data with the multiple model decision trees and the at least one incremental decision tree;
regarding establishing time of the multiple model decision trees and that of the at least one incremental decision tree as weights for determining comprehensive performance, and sorting the prediction accuracy rates to the incremental data, wherein a weight of a decision tree with long establishing time is less than a weight of a decision tree with short establishing time.

8. The data processing method according to claim 1, wherein the number of the at least one incremental decision tree is determined according to the number of the multiple model decision trees.

9. The data processing method according to claim 8, wherein the number of the at least one incremental decision tree is equal to 10% to 30% of the number of the multiple model decision trees.

10. The data processing method according to claim 1, further comprising:
obtaining the incremental data within a predetermined time period, and determining the generated number of the at least one incremental decision tree based on whether the classification model exists,
wherein the at least one incremental decision tree is generated according to the incremental data, if the classification model exists.

11. The data processing method according to claim 10, further comprising:
creating the classification model consisting of the multiple model decision trees according to historical data, if the classification model does not exist, wherein the historical data refers to data that has been classified.

12. A data processing device, comprising a memory, a processor, and a computer program stored in the memory and executed by the processor, wherein when the computer program is executed by the processor, the processor implements the following steps:
generating at least one incremental decision tree according to incremental data;
predicting the incremental data based on multiple model decision trees in a classification model and the at least one incremental decision tree to obtain prediction results; and
updating the classification model according to the prediction results.

13. The data processing device according to claim 12, wherein when implementing the step of generating at least one incremental decision tree according to incremental data, the processor specifically implements the following steps:
extracting multiple sample sets with replacement based on the incremental data; and
generating the at least one incremental decision tree based on the multiple sample sets, wherein the number of the at least one incremental decision tree is determined based on the number of the multiple model decision trees.

14. The data processing device according to claim 12, wherein when implementing the step of updating the classification model according to the prediction results, the processor specifically implements the following steps:
obtaining, according to the prediction results, comprehensive performance of the at least one incremental decision tree and that of the multiple model decision trees; and
selecting, based on the comprehensive performance of the at least one incremental decision tree and that of the multiple model decision trees, a predetermined number of decision trees from the multiple model decision trees and the at least one incremental decision tree to act as model decision trees in an updated classification model.

15. The data processing device according to claim 14, wherein when implementing the step of obtaining, according to the prediction results, comprehensive performance of the at least one incremental decision tree and that of the multiple model decision trees, the processor specifically implements the following step:
determining the comprehensive performance based on establishing time and prediction accuracy rates to the incremental data of the at least one incremental decision tree and that of the multiple model decision trees.

16. The data processing device according to claim 12, wherein when implementing the step of predicting the incremental data based on multiple model decision trees in a classification model and the at least one incremental decision tree to obtain prediction results, the processor specifically implements the following step:
performing label prediction operations to the incremental data based on the multiple model decision trees in the classification model and the at least one incremental decision tree.

17. The data processing device according to claim 16, wherein when implementing the step of predicting the incremental data based on multiple model decision trees in a classification model and the at least one incremental decision tree to obtain prediction results, the processor specifically further implements the following steps:
determining, according to results of the label prediction operations, prediction accuracy rates to the incremental data with the multiple model decision trees and the at least one incremental decision tree;
regarding establishing time of the multiple model decision trees and that of the at least one incremental decision tree as weights for determining comprehensive performance; and
sorting the prediction accuracy rates to the incremental data, wherein a weight of a decision tree with long establishing time is less than a weight of a decision tree with short establishing time.

18. The data processing device according to claim 12, wherein when implementing the step of generating at least one incremental decision tree according to incremental data, the processor specifically implements the following steps:
obtaining the incremental data within a predetermined time period; and
determining the generated number of the at least one incremental decision tree based on whether the classification model exists; wherein the at least one incremental decision tree is generated according to the incremental data, if the classification model exists.

19. The data processing device according to claim 18, wherein when implementing the step of generating at least one incremental decision tree according to incremental data, the processor specifically further implements the following step:
creating the classification model consisting of the multiple model decision trees according to historical data, if the classification model does not exist, wherein the historical data refers to data that has been classified.

20. A computer readable storage medium storing a data processing program for causing a processor to execute the data processing method according to claim 1.
